(19) United States
(12) Patent Application Publication
(10) Pub. No.: US 2004/0113894 A1
(43) Pub. Date: Jun. 17, 2004

(54) Display device for loom

(75) Inventors: Akihiko Yamamoto, Ishikawa-ken (JP); Morikazu Yamazaki, Ishikawa-ken (JP)

Correspondence Address: John W. McIlvaine, Esq., 700 Koppers Building, 436 Seventh Avenue, Pittsburgh, PA, 15219-1818, US

(73) Assignee: TSUDAKOMA KOGYO KABUSHIKI KAISHA

(21) Appl. No.: 10/692,604

(22) Filed: Oct. 24, 2003

(30) Foreign Application Priority Data
Dec. 11, 2002 (JP) 2002-359828

(51) Int. Cl. G09G 5/00

(52) U.S. Cl. 345/173

(57) ABSTRACT

A display device for a loom comprising a display unit provided with a touch screen; a display command unit capable of making said display unit display at least one of operation control buttons on said touch screen; and a button condition command unit capable of making at least one of operation control buttons to be interlocked, either one of in the non-displaying state or in the ineffective state according to a stopping state of the loom.

### BACKGROUND OF THE INVENTION

1. Field of the Invention

The present invention relates to a display device, including a touch-screen type of display having a touch screen capable of displaying control buttons, used for the interlock control of a loom according to the stopping state of the loom through the operation of the control buttons displayed on the touch screen.

2. Description of the Related Art

Patent document 1 discloses a display device for a loom.

The display device disclosed in Patent document 1 includes a storage unit for storing data on the weaving operations of the loom, a data selection unit for selectively switching data representing the respective switching operations of a plurality of operators concerned with weaving, a control unit for reading the data from the storage unit according to the switching operation of the data selection unit, and a display unit for displaying data transmitted thereto from the control unit.

In the display device mentioned in Patent document 1, ever when the loom has stopped due to a mis-pick or the like, if the operator operates the control button, a control signal corresponding to operated control button is inputted to a loom controller for controlling the loom, the loom controller operates the loom according to the signal given thereto.

Therefore, the loom provided with this display device is provided with an interlocking circuit that receives a loom state signal (one of signals indicating all the states of the loom including a stopping state), and makes a proper function of the loom unable to operate even if the control signal is given to the loom controller when the loom state signal indicates a stopping state of the loom.

[Patent Document 1]

JP-A No. 6-81251

The aforesaid loom controller provided with the interlocking circuit that withholds providing an operation signal to operate the loom has a complicated circuit configuration, and makes the electrical system of the loom complicated. Thus, when a new display device is developed, the design of the complicated circuit for the loom controller needs to be changed so as to conform to the new display device.

### SUMMARY OF THE INVENTION

Accordingly, it is an object of the present invention to provide a touch-screen display device for a loom, provided with control buttons displayed on a touch screen and capable of being operated to achieve the interlocking control of the loom according to the stopping state of the loom, to thereby simplify the circuit configuration of the loom controller.

According to the present invention, a display device for a loom comprises: a display unit provided with a touch screen; a display command unit capable of making the display unit display at least one of operation control buttons on the touch screen; and a button condition command unit capable of making at least one of operation control buttons to be interlocked, either one of in the non-displaying state or in the ineffective state according to a stopping state of the loom.

The display device may further comprise an operation command unit that makes an operation button included in the operation control buttons effective only when the operation button is pressed so as to meet a specific condition; wherein the operation control buttons include at least one the operation button and at least one permission button, the operation button is effective only when the operation button and the permission button are pressed simultaneously, and at least the operation control button to be interlocked is either the operation button or the permission button.

The operation control buttons may include at least one operation button, and the operation control button to be interlocked may be the operation button.

The display device may further comprise an operation command unit that makes an operation button included in the operation control buttons effective only when the operation button is pressed so as to meet a specific condition; wherein the operation control buttons further include one permission button, the operation button is effective when the operation button and the permission button are pressed simultaneously, and the operation control button to be interlocked is the permission button.

The display device may further comprise an operation command unit that makes the operation button effective when the operation button is pressed so as to meet a specific condition; wherein the operation control buttons further include a plurality of permission buttons, the operation button is effective when the operation button and the permission button are pressed simultaneously, and the operation control button to be interlocked is the operation permission button.

The display device may further comprise an OR command unit that makes at least one of the operation control buttons in non-display state or in ineffective state depending on OR of stopping states when a plurality of the stopping states occur simultaneously.

In the display devices according to the present invention, the operation control buttons including the operation button or the permission button to be interlocked and displayed on the touch screen is made either or ineffective state depending on the stopping state of the loom. Therefore, a control signal corresponding to the operation control button including the interlocked operation buttons or the permission button is not give to the loom controller. Consequently, the loom controller does not need to be provided with any interlocking circuit, the interlocking circuit of the loom controller may be omitted, and hence any interlocking circuit associated with the display device does not need to be taken into consideration in designing the circuit of the loom controller. Thus, the circuit of the loom controller is simplified and the circuit of the loom controller has a large degree of freedom of changing circuit configuration.

The display devices according to the present invention are provided additionally with a circuit for displaying the operation control button including the operation button or the permission button to be interlocked. Therefore, any operating buttons for operating push-buttons of contact switch type do not need to be arranged around the display device. Thus, the loom controller does not need to be provided with any interlocking circuit and hence the electrical system of the loom is simplified.

In the display devices according to the present invention, the operation control button including the operation button and the permission button can be either removed from the touch screen or made inoperative. Thus, faulty operation of the loom can surely be prevented even if the loom is operated by a plurality of operators.

### BRIEF DESCRIPTION OF THE DRAWINGS

FIG. 1A is a block diagram of a loom provided with a display device in a first embodiment according to the present invention;

FIG. 1B is a block diagram of a display control unit included in the display device shown in FIG. 1A;

FIG. 2 is a view of a screen included in the display device shown in FIG. 1A;

FIG. 3 is a view of the screen included in the display device shown in FIG. 1A in another state;

FIG. 4 is a view of the screen included in the display device shown in FIG. 1A in a third state;

FIG. 5 is a view of a screen included in a display device in a second embodiment according to the present invention;

FIG. 6 is a view of a screen included in a display device in a third embodiment according to the present invention;

FIG. 7 is a view of the screen shown in FIG. 6 in a state different from that shown in FIG. 6;

FIG. 8 is a view of a screen in a modification of the screen shown in FIG. 6;

FIG. 9 is a view of a screen included in a display device in a fourth embodiment according to the present invention;

FIG. 10 is a view of a screen included in the display device in the fourth embodiment in a state different from that shown in FIG. 9; and

FIG. 11 is a view of a screen in a modification of the screen shown in FIG. 9.

### DETAILED DESCRIPTION OF THE PREFERRED EMBODIMENTS

First Embodiment

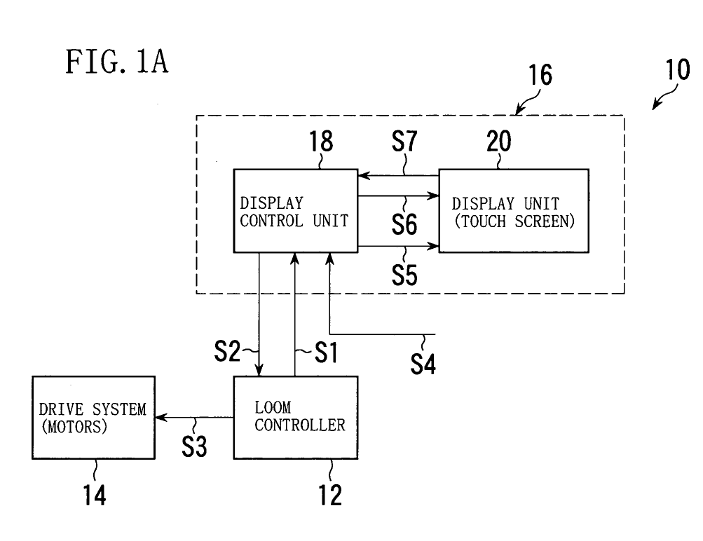

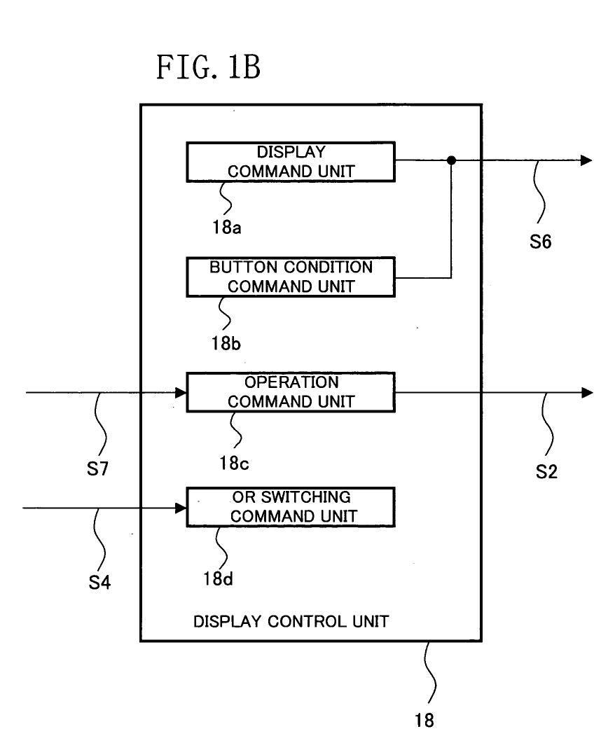

Referring to FIGS. 1 to 4, a loom 10 has a loom controller 12, a drive system 14, and a display device 16. The display device 16 has a display control unit 18 and a display unit 20.

The display control unit 18 has a display command unit 18a, a button condition command unit 18b, an operation command unit 18c and an OR switching command unit 18d.

The constitution of the loom 10 will be described with reference to FIG. 1.

The loom controller 12 sends a data signal S1 carrying various data of the loom 10 to the display control unit 18. The loom controller 12 provides a drive signal S3 to the drive system 14. The drive signal S3 is generated on the basis of a command signal S2 received from the display control unit 18. The command signal S2 indicates a various of the operations to be carried out by the loom 10, and the drive signal S3 indicates an instruction for instructing the drive system 14 for the operation indicated by the command signal S2.

The drive system 14 operates according to the drive signal S3. For example, the drive system 14 includes a main motor for driving the main shaft of the loom 10, a motor for driving a shedding mechanism, solenoid actuators for operating stopping pins and various drive devices.

The display control unit 18 receives the data signal S1 from the loom controller 12 and a loom state signal S4. The display control unit 18 of the display device 16 in the first embodiment determines the operating state of the loom 10 on the basis of the loom state signal S4 indicating the current state of the loom 10, and gives a display signal S5 carrying a display command for displaying at least one operation button 22 on the screen of the display unit 20 to the display unit 20.

The operation buttons 22 are depressed to start or stop the loom 10.

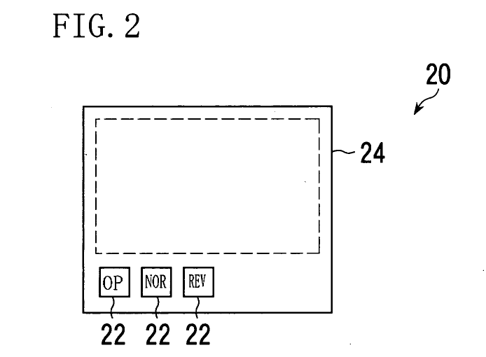

The display control unit 18 gives the display unit 20 an interlocking signal S6 carrying a display inhibition command preventing the display unit 20 from displaying the operation button 22 (FIG. 2) preset for each stopping state when the loom state signal S4 indicates a stopping state of the loom 10.

The loom state signals S4 are those respectively indicating stopping states shown in Table 1. The table 1 may be stored previously in the display control unit 18.

TABLE 1

| | | Condition of the operation | | |
|---|---|---|---|---|
| | | button when the | | |
| | | interlocking signal | | |
| | | S6 is ON | | |
| Loom | | | Normal | |
| state | Status of interlocking | Operation | rotation | Reverse |
| signal S4 | signal S6 | button | button | button |
| Trouble | ON at the occurrence of a trouble and OFF after | Not | Not | Not |
| (Loom | the removal of the trouble | displayed | displayed | displayed |
| stop) | | | | |
| Safety | ON when the safety sensor detects a thing and | Not | Not | Not |
| sensor | OFF when the safety sensor detects nothing | displayed | displayed | displayed |
| Normal | ON when the phase of the main shaft is in the | Displayed | Not | Displayed |
| rotation | dobby normal rotation inhibiting range and | | displayed | |
| inhibition | OFF when the phase of the main shaft is | | | |
| | outside the dobby normal rotation inhibiting | | | |
| | range | | | |
| Reverse | ON when the phase of the main shaft is in the dobby | Displayed | Displayed | Not |
| rotation | reverse rotation inhibiting range and OFF when the | | | displayed |
| inhibition | phase of the main shaft is outside the dobby reverse | | | |
| | rotation inhibiting range | | | |
| Weft stop | ON at a weft stop and OFF after repair | Not | Displayed | Displayed |
| | | displayed | | |

“Trouble (Loom stop)” signifies that troubles so as to be stopped the loom 10 to eliminate of the same was occurred.

“Safety sensor” is a transmission type sensor disposed side of the cloth fell, having a sensing range corresponding to the width of the reed, and capable of detecting the operator. The transmission type sensor detects an operator's hand and such during weaving.

“Normal rotation inhibition” and “Reverse rotation inhibition” signify the inhibition of the normal rotation and the reverse rotation, respectively, of the main shaft of the loom 10 when the phase of the main shaft is in the inhibition range in constitution of the loom 10.

“Weft stop” signifies a state where a weft feeler cannot detect arrival of the weft.

When an operation button displayed on the screen of the display unit 20 is depressed, the display unit 20 gives an operation signal S7 carrying information specified by the operation button to the display control unit 18.

The condition of the screen while the loom 10 is operating normally will be described with reference to FIG. 2 typically showing the screen.

The display unit 20 has a screen 24. At least one operation button 22, i.e., a visible image, is displayed on the screen 24. The operation button 22 is specified by an input signal on the basis of a display signal S5 or an interlocking signal S6 provided by the display control unit 18.

Data on the loom 10, such as data on weaving conditions including a picking condition, is displayed in an upper region delineated by dotted lines in the screen 24. The data on the loom 10 and the operation buttons 22 to be interlocked may be displayed on separate screens or separate touch screens, respectively.

Rectangular operation buttons 22, 22, 22 are displayed in a lower region of the screen 24. The operation buttons 22, 22 and 22 are a start button for entering a start signal to start the loom 10 for the normal operation, a normal rotation button for entering a normal rotation signal to rotate the main shaft of the loom 10 in the normal direction, and a reverse button for entering a reverse rotation signal to rotate the main shaft of the loom 10 in the reverse direction, respectively. The operation buttons 22 are icons respectively marked with characters indicating functions, such as “OP” (operation), “NOR” (normal rotation) and “REV” (reverse rotation). The operation buttons 22 may be pictures or icons indicating an operation button, a normal rotation button and a reverse rotation button, respectively.

The operator touches (pushes down) an area on the screen 24 corresponding to the operation button 22 with “OP”, “NOR” or “REV”, i.e., presses the operation button 22 with “OP”, “NOR” or “REV”. Then, the display unit 20 sends the operation signal S7 carrying information specified by the pushed operation button 22 to the display control unit 18.

Upon the reception of the operation signal S7, the display control unit 18 decides whether or not there is any trouble to stop the loom 10, and gives a command signal S2 to the loom controller 12.

The display unit 20 receives display signals S5 requesting displaying the operation buttons 22 with “OP”, “NOR” and “REV”, and the interlocking signals S6 of “ON” and “OFF”, and displays on the screen 24 the operation buttons specified by the display signals S5 other than the operation button 22 specified by the interlocking signal S6 in the ON state.

While the loom 10 is operating normally, the display control unit 18 that has received the data signal S1 from the loom controller 12 gives the display signal S5 for displaying the condition of the loom controller 12 on the screen 24, and the interlocking signal S6 in the OFF state to display the operation button 22 with “OP”, “NOR” or “REV” on the screen 24 to the display unit 20. Data on the current condition of the loom 10 controlled by the loom controller 12 is displayed in an upper region of the screen 24.

When the operation button 22 with “OP” displayed in a lower area on the screen 24 is pushed, the display unit 20 gives the operation signal S7 indicating that the operation button 22 with “OP” is pushed to the display control unit 18. Then the display control unit 18 gives the command signal S2 corresponding to the operation signal S7 to the loom controller 12. Then, the loom controller 12 gives a drive signal S3 corresponding to the command signal S2 to the drive system 14 and the drive system 14 operates accordingly.

If the loom 10 stops due to some trouble which the loom 10 operate normally, the loom 10 gives the loom state signal S4 in the ON state including the cause of stoppage and stopping state to the display control unit 18.

When the loom 10 decides that the cause of stoppage is a trouble corresponding to “Trouble (Loom stop)”, the loom 10 gives a loom state signal S4 indicating “Trouble (Loom stop)” to the display control unit 18.

Upon the reception of the loom state signal S4 indicating “Trouble (Loom stop)”, the display control unit 18 reads the preset operation button 22 not to be displayed corresponding to the loom state signal S4 from Table 1, and the button switching commanding unit of the display control unit 18 gives the interlocking signal S6 in the ON state carrying information about the operation button 22 not to be displayed to the display unit 20.

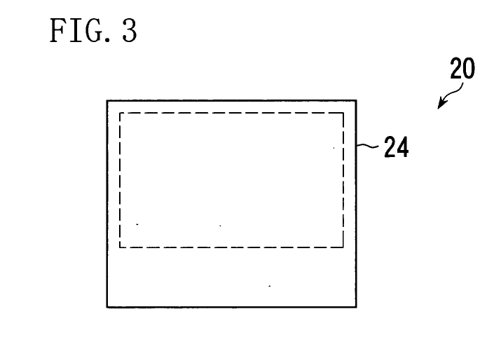

In this embodiment, in a state corresponding to “Trouble (Loom stop)”, all the operation buttons 22 with “OP”, “NOR” and “REV” must not be displayed, all the operation buttons 22 with “OP”, “NOR” and “REV” are not displayed on the screen 24 as shown in FIG. 3, and the display control unit 18 and the display unit 20 make all the operation buttons 22 ineffective.

Thus, the loom 10 does not perform any operation corresponding to the operation buttons 22 with “OP”, “NOR” and “REV” even if the operator touches the screen 24 accidentally while the operator is inspecting the loom 10 for the cause of stoppage because all the operation buttons 22 with “OP”, “NOR” and “REV” are not displayed.

If the loom 10 decides that the stopping state is a state of “Reverse rotation inhibition” and “Weft stop”, the loom 10 gives the loom state signal S4 carrying information about the state of “Reverse rotation inhibition” and “Weft stop” to the display control unit 18. Then, the OR switching command unit 18d of the display control unit 18 reads the operation buttons 22 not to be displayed from the Table 1 according to the loom state signal S4, and the display command unit 18a of the display control unit 18 gives the interlocking signal S6 in the ON state carrying information about the state of “Reverse rotation inhibition” and “Weft stop” to the display unit 20.

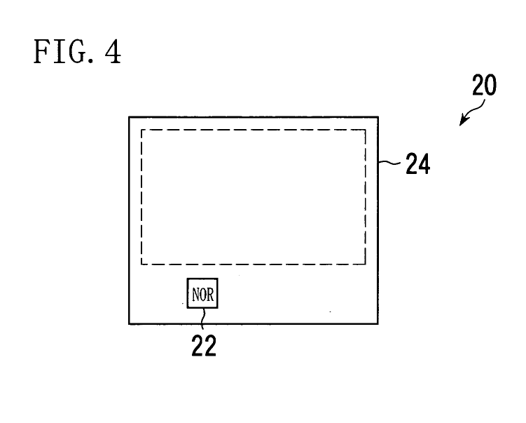

If the loom 10 is in the state of “Reverse rotation inhibition” and “Weft stop”, the operation buttons 22 with “OP” and “REV” must not be displayed. Therefore, only the operation button 22 with “NOR” is displayed on the screen 24 and the operation buttons 22 with “OP” and “REV” is not displayed as shown in FIG. 4, and the display control unit 18 and the display unit 20 treat only the operation button 22 with “NOR” as effective.

Since only the effective operation button 22 with “NOR” is displayed on the screen 24, and the operation buttons 22 with “OP” and “REV” to be interlocked are not displayed on the screen 24, the operator is able to press the operation button 22 with “NOR” and is unable to press the operation buttons 22 with “OP” and “REV”. Thus, the command signals S2 representing functions specified by the operation buttons 22 with “OP” and “REV” are not given to the loom controller 12.

Even if the areas on the screen 24 for the operation buttons 22 with “OP” and “REV” to be interlocked are touched in a state where the operation buttons 22 with “OP” and “REV” to be interlocked are not displayed, the display unit 20 gives operation signals S7 not representing the functions specified by the operation buttons 22 with “OP” and “REV”.

After the operator has eliminated the cause of the trouble that causes the loom 10 to stop, the interlocking signals S6 for interlocking the operation buttons 22 with “OP” and “REV” change from the ON state to the OFF state to unlock the operation buttons 22 with “OP” and “REV” and to display the operation buttons 22 with “OP” and “REV” on the screen 24.

The operation buttons 22 may be unlocked by operating control buttons included in the display unit 20 to unlock the operation buttons 22, i.e., to change the interlocking signals S6 from the ON state to the OFF state, or may be unlocked by the agency of a logic circuit capable of unlocking the operation buttons 22 and included in the display control unit 18 when the operation button 22 with “REV” is pressed after repairing work, such as work for removing a mis-picked weft yarn, has been accomplished.

The operation buttons 22 may be unlocked by pressing the operation buttons 22 while the loom 10 is stopping or by detecting a signal indicating the inching rotation of the main shaft of the loom 10 and provided by an encoder combined with the main shaft of the loom 10. More concretely, in a state of “Weft stop”, the interlocking state may be cancelled when the operation button 22 with “REV” is pressed after a mis-picked weft yarn has been removed or when the main shaft of the loom 10 starts an inching rotation in response to the operation of the operation button 22 with “REV”, i.e., when a signal provided by the encoder combined with the main shaft is detected.

Thus, the inadvertent operations of the operator, such as a careless operation for restarting the loom 10 for weaving without eliminating the cause of stoppage, such as restarting the loom 10 stopped due to “Weft stop” without removing the mis-picked weft yarn, can be prevented, which contributes to the quality improvement of the woven fabric.

Second Embodiment

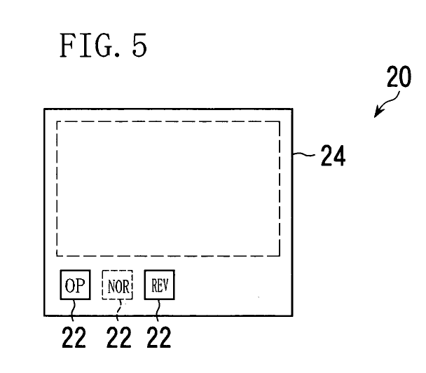

A display device in a second embodiment according to the present invention will be described. Referring to FIG. 5, upon a reception of the interlocking signal S6 in the “ON” state from a display control unit 18, the display unit 20 dims operation buttons 22 to be interlocked to inform the operator that the dimmed operation buttons 22 are interlocked and inoperative.

A description will be made of an operation to be performed by the display device when the loom state signal S4 carrying information indicating “Normal rotation inhibition” is given to the display control unit 18 caused by stopping of the loom 10, with reference to FIG. 5 showing a screen 24.

A button condition command unit 18b included in the display control unit 18 gives the display signal S5 and the interlocking signal S6 to dim the operation button 22 with “NOR” to the display unit 20. Upon the reception of the display signal S5 and the interlocking signal S6, the display unit 20 dims the operation button with “NOR” shown on the screen 24. The color of “NOR” may be changed instead of dimming “NOR”. For example, “NOR” may be displayed in red that is suggestive of warning. A mark “X” may be superposed on “NOR”.

The operator is able to understand surely and instantly from the dimmed condition of the operation button 22 with “NOR” that the loom 10 has stopped and the rotation of the main shaft of the loom 10 in the normal direction is inhibited by looking at the screen 24.

Even if the operator presses the thus interlocked operation button 22 with “NOR”, the display control unit 18 does not give the command signal S2 based on the operation signal S7 carrying information represented by the operation button 22 with “NOR” to the loom controller 12 (interlocks the operation button 22 with “NOR”) because the operation signal S7 sent from the display unit 20 to the display control unit 18 does not correspond to the operation buttons 22 with “OP” and “REV” displayed on the basis of the display signals S5.

The display unit 20 may make the operation button 22 with “NOR” to be interlocked ineffective so as to respond to pushing, and may stop sending the operation signal S7 carrying information represented by the operation button 22 with “NOR” to the display control unit 18.

Since the operation button with “NOR” to be interlocked is thus made ineffective, the main shaft of the loom 10 does not rotate in the normal direction even if the operator presses the operation button 22 with “NOR”.

Third Embodiment

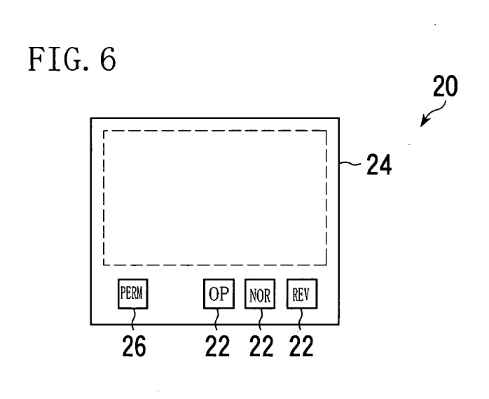

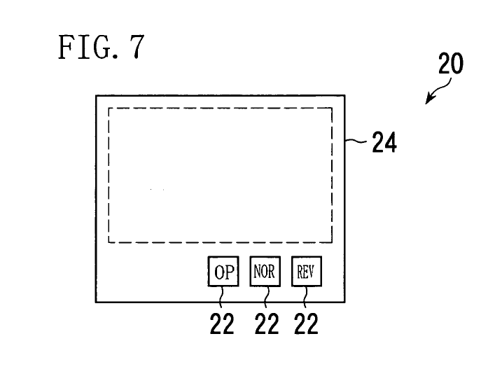

A display device in a third embodiment according to the present invention will be described with reference to FIGS. 6 and 7. Referring to FIGS. 6 and 7, the display control unit 18 includes the operation command unit 18c that makes the operation button 22 effective when the same operation button 22 is pressed together with a permission button 26 with “PERM”.

Referring to FIG. 6, while the loom state signal S4 carrying information about the cause of stoppage is not given to the display control unit 18, the operation buttons 22 with “OP”, “NOR” and “REV”, and the permission button 26 with “PERM” representing to make the operation buttons 22 effective are displayed on the screen 24.

When the operator needs to operate the loom 10 in the normal operation, the operator presses the proper operation button 22 and the permission button 26 displayed on the screen 24 simultaneously. Then, the operation command unit 18c of the display control unit 18 decides that the button pressing operation made by the operator is effective, and an operation specified by the pressed operation button 22 is started.

Operations that are to be performed when the loom state signal S4 corresponding to a state “Trouble (Loom stop)” or “Safety sensor” is given to the display control unit 18 will be described with reference to FIG. 7 showing the screen 24.

A button condition command unit 18b included in the display control unit 18 sends the interlocking signal S6 in the “ON” state to the display unit 20 to remove the permission button 26 with “PERM” from the screen 24.

Upon the reception of the interlocking signal S6 in the ON state, the display unit 20 displays the operation buttons 22 with “OP”, “NOR” and “REV” on the screen 24 and extinguishes the permission button 26 with “PERM”.

Since the permission button 26 is not displayed on the screen 24, the operator is unable to press the operation button 22 together with the permission button 26. Thus, the operation buttons 22 are interlocked.

The third embodiment may make the operation buttons 22 ineffective by either of methods previously described in connection with the first and the second embodiment instead of removing the permission button 26 from the screen 24.

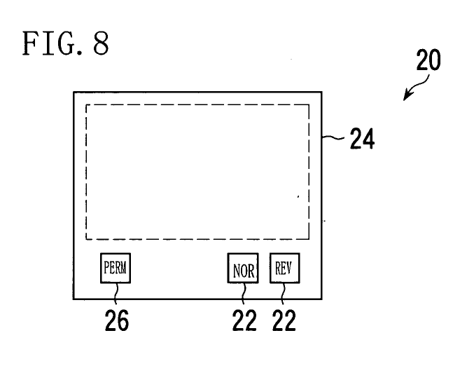

The third embodiment may remove or make ineffective the operation buttons 22 to be interlocked individually as mentioned in the description of the first and the second embodiment instead of removing or making ineffective the permission button 26. Only the operation button 22 with “OP” is not displayed on the screen 24 showing FIG. 8.

As mentioned in the description of the second embodiment, the permission button 26 or the operation button 22 to be interlocked may be made ineffective and may be dimmed or shown in a color different from that of the other operation buttons 22.

Fourth Embodiment

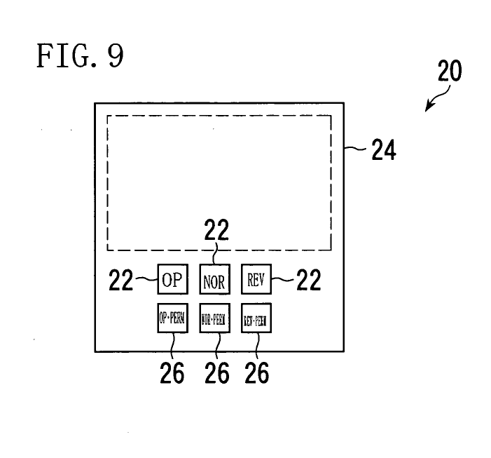

A display device in a fourth embodiment according to the present invention will be described with reference to FIGS. 9 to 11. Referring to FIGS. 9 to 11, the operation buttons 22 and the permission buttons 26 are shown on a screen 24. The number of the operation buttons 22 is equal to that of the permission buttons 26. The operation buttons 22 and the permission buttons 26 respectively corresponding to the operation buttons 22 are used in combination. The operation command unit 18c included in the display control unit 18 makes the pressed operation button 22 effective when the same operation button 22 and the permission button 26 corresponding to the pressed operation button 22 are pressed simultaneously.

While the loom state signal S4 carrying information about the cause of stoppage is not given to the display control unit 18, the operation buttons 22 with “OP”, “NOR” and “REV”, and the permission buttons 26 with “OP•PERM”, “NOR•PERM” and “REV•PERM” respectively corresponding to the operation buttons 22 with “OP”, “NOR” and “REV” are displayed on the screen 24 as shown in FIG. 9. When the operation button 22 and the permission button 26 corresponding to the operation button 22 are pressed simultaneously, the pressed operation button 22 is effective.

The operator presses the desired operation button 22 and the permission button 26 corresponding to the same operation button 22 simultaneously. Then, the display control unit 18 makes the pressed operation button 22 effective, and the loom 10 performs an operation specified by the pressed operation button 22.

If the operator presses the desired operation button 22 and the permission button 26 not corresponding to the desired operation button 22 simultaneously, the display control unit 18 and a display unit 20 make the pressed operation button 22 ineffective and hence the loom 10 does not perform an operation specified by the pressed operation button 22.

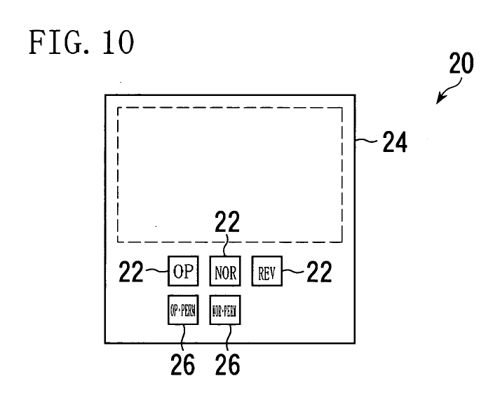

Operations when the loom state signal S4 indicating “Reverse rotation inhibition” is given to the display control unit 18 when the loom 10 is stopped will be described with reference to FIG. 10 showing the screen 24.

A button condition command unit 18b included in the display control unit 18 removes the permission button 26 with “REV•PERM” corresponding to the operation button 22 with “REV” specified by the loom state signal S4.

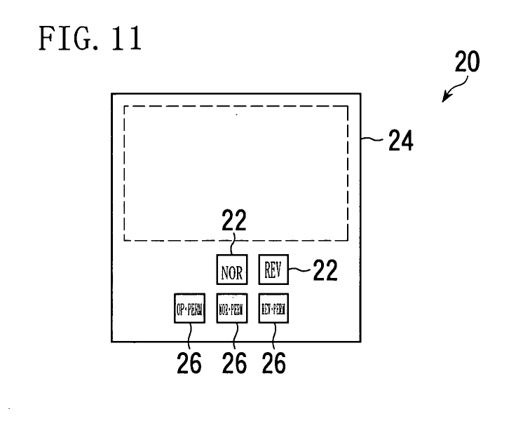

The fourth embodiment may remove the operation button 22 instead of the permission button 26 corresponding to the operation button 22. FIG. 11 shows the screen 24 not displaying the operation button 22 with “OP”. The operation button 22 with “OP” may be made ineffective or the permission button 26 with “OP PERM” may be made ineffective instead of removing the operation button 22 with “OP”.

As mentioned in the description of the second embodiment, the operation button 22 to be interlocked or the permission button 26 to be interlocked may be made ineffective or may be dimmed.

Modifications

A picture displayed on the screen 24 may be replaced with another picture instead of individually removing the operation buttons 22 or the permission buttons 26. The picture may entirely be replaced with another picture or only a picture showing the operation buttons 22 in a certain state may be replaced with another picture showing the operation buttons 22 in a different state.

The loom state signals may be those other than those indicating “Trouble (Loom stop)”, “Safety sensor”, “Normal rotation inhibition”, “Reverse rotation inhibition” and “Weft stop” shown in Table 1. Possible loom state signals may include those indicating states that inhibit operator's specific operations, such as states respectively for the automatic cleaning of the loom, the initialization of the loom, and the warming-up operation in starting the loom in the early morning, although the loom is normally operated.

The interlocking operation and the unlocking operation are executed by software according to programs.

Although the invention has been described in its preferred embodiments, the present invention is not limited thereto in its practical application and changes and modifications may be made without departing from the scope of the invention.

What is claimed is:

1. A display device for a loom, comprising:
a display unit provided with a touch screen;
a display command unit capable of making said display unit display at least one of operation control buttons on said touch screen; and
a button condition command unit capable of making at least one of operation control buttons to be interlocked, either one of in the non-displaying state or in the ineffective state according to a stopping state of the loom.

2. The display device according to claim 1 further comprising an operation command unit that makes an operation button included in the operation control buttons effective only when the operation button is pressed so as to meet a specific condition;
wherein the operation control buttons include at least one the operation button and at least one permission button, the operation button is effective only when the operation button and the permission button are pressed simultaneously, and at least the operation control button to be interlocked is either the operation button or the permission button.

3. The display device according to claim 1, wherein the operation control buttons include at least one operation button, and the operation control button to be interlocked is the operation button.

4. The display device according to claim 3 further comprising an operation command unit that makes an operation button included in the operation control buttons effective only when the operation button is pressed so as to meet a specific condition;
wherein the operation control buttons further include one permission button, the operation button is effective when operation button and the permission button are pressed simultaneously, and the operation control button to be interlocked is the permission button.

5. The display device according to claim 3 further comprising an operation command unit that makes the operation button effective when the operation button is pressed so as to meet a specific condition;
wherein the operation control buttons further include a plurality of permission buttons, the operation button is effective when the operation button and the permission button are pressed simultaneously, and the operation control button to be interlocked is the permission button.

6. The display device according to claim 1 further comprising an OR command unit that makes at least one of the operation control buttons in non-display state or ineffective state depending on OR of stopping states when a plurality of the stopping states occur simultaneously.
